(19) United States
(12) Patent Application Publication
(10) Pub. No.: US 2005/0171619 A1
(43) Pub. Date: Aug. 4, 2005

(54) Real time electronic parameter control

(76) Inventor: Glenn Mark Wakefield, Tempe, AZ (US)

Correspondence Address: Glenn Wakefield, 1416 East Carmen Street, Tempe, AZ, 85283, US

(21) Appl. No.: 11/012,054

(22) Filed: Dec. 14, 2004

Related U.S. Application Data
(60) Provisional application No. 60/535,280, filed on Jan. 10, 2004.

(51) Int. Cl. G05B 11/01

(52) U.S. Cl. 700/11; 700/19

(57) ABSTRACT

Real time electronic parameter control may be applied to integrate/unintegrated electromechanical devices and to circuit design components. This may be accomplished for example, by replacing one component with a selection of variable impedance components. The components are connected up in different ways by appropriate circuitry. A microprocessor rearranges the components in real time. This optimizes circuit performance which allows for exceptionally fast electromechanical devices and improves the overall characteristics of the device (i.e. torque/force, speed).

### CROSS-REFERENCE TO RELATED APPLICATIONS

Provisional application No. 60/526,002, filed December 2003.

Provisional application No. 60/535,280, filed January 2004.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This patent application applies to the field of electromechanical devices and circuit design.

Circuit design has fundamentally remained unchanged for many years.

### BRIEF SUMMARY OF THE INVENTION

Real time electronic parameter control may be applied to integrate/unintegrated electromechanical devices and to circuit design components. This may be accomplished for example, by replacing one component with a selection of variable impedance components. The components are connected up in different ways by appropriate circuitry. A microprocessor rearranges the components in real time. This optimizes circuit performance which allows for exceptionally fast electromechanical devices and improves the overall characteristics of the device (i.e. torque/force, speed).

### BRIEF DESCRIPTION OF THE SEVERAL VIEWS OF THE DRAWING

Not Applicable

### DETAILED DESCRIPTION OF THE INVENTION

Real time electronic parameter control may be applied to electromechanical devices (linear/rotary motors, linear/rotary solenoids, magnetic levitation trains, electromagnetic launch systems, electromechanical shock absorbers, any electromechanical device) and to circuit design components (i.e. capacitors, inductors(coils, composite coils), resistors, transformers, transistors, any linear/nonlinear component). Real time electronic parameter control may be implemented discretely and on an integrated circuit. Real time electronic parameter control may rapidly adapt to changing conditions permitting a wide control of signal patterns. Real time electronic parameter control is under microprocessor control. Real time electronic parameter control may be implemented by replacing one (or more) component by one or more components of varying impedance. Through real time electronic parameter control, one or more components may be made to function as an integrated component of variable impedance by connecting the components in different ways (i.e. parallel, series, combination parallel and series, use of only part of set). The connected components are rearranged in real time to optimize circuit performance. Real time electronic parameter control may be applied to the primary and secondary winding/circuit of transformers/power supplies which may allow the available power and the form of the available power to be varied in real time. Real time electronic parameter control may be applied to low/normal/high power circuits and to any integrated/unintegrated electromechanical devices. The integrated electromechanical device (all parts within the same structure) may include the electromechanical unit, sensors (i.e. position, velocity, acceleration, torque, force, any appropriate sensor), microprocessor (i.e. control software), appropriate circuitry (i.e. drive electronics), power supply, communications, and appropriate interface port. Real time electronic parameter control may be applied to any parts of the integrated electromechanical device or to any parts of an unintegrated electromechanical device. This may permit exceptionally fast response times for the electromechanical devices improving overall characteristics of the device (i.e. torque/force, speed).

Most electromechanical devices (i.e. listed above) are based on a coil. A coil is characterized as one or more loops with each loop consisting of one or more windings; the windings may be of arbitrary composition and shape; the distance between loops is arbitrary; the voltage/current in each loop may be controlled by appropriate electronics; the coil may trace out any curve in three dimensional space; the coil may be coreless or may possess a core; one or more arbitrary shaped components may be joined together to form the core; each core component may be of arbitrary composition and different patterned coatings; each loop may be separated from other loops by material of arbitrary composition; each winding may be separated from other windings by material of arbitrary composition. A composite coil may be characterized as two or more coils; if appropriate, the coil cores may be attached to an object being moved; each coil may be separated from other coils by material of arbitrary composition; the function of the composite coil is controlled electronically.

If a coil possesses a core it may be fixed or it may be moveable. The response time of a moveable core in relation to the applied voltage/current is determined by 1.) the inertia of the core, 2.) the time constant of the coil, 3.) the force (proportional to the number of windings per unit length, current and frequency response/permeability of the material composing the core) and 4.) the power supply/power electronics (applied voltage, available current). The inertia of the core may be minimized by using a hollow low density core. The inside surface of the core may take on any characteristics or patterns. The physical properties and the thickness of the core (shell) must be taken into consideration. The inside of the hollow core may be partially (any pattern) or fully coated/lined with a compound of high magnetic resistance. This may help to concentrate the magnetic field within the core; but, its weight contribution and altered field distribution need evaluation. The shape of the core may be appropriately designed for the particular application (i.e. fast penetration into high pressure gas/liquid). Under electronic control, this may permit precise arbitrary movement patterns of the core. The time constant of the coil may be decreased by increasing the voltage and by reducing the self/mutual inductance. The voltage may be limited by the system design. The self/mutual inductance may be limited by decreasing the number of windings per length in each loop, decreasing the volume of each loop and appropriately increasing the magnetic resistance among the loops/windings. The physical properties of the winding material must be taken into consideration. If appropriate, the windings may be coated with an electrically insulating compound to prevent the shorting of wires. The inductance of an infinitely long inductor may be determined as L=u.n.n.l.A where L=inductance, u=permeability, n=windings per unit length, l=length and A=area. The magnetic field anywhere in the cross section of an infinitely long inductor may be determined as B=u.n.i where B=magnetic field, u=permeability, n=windings per unit length and i=current. The area, length and number of windings per unit length of an inductor must be decreased to minimize inductance. The area of a typical coil may be minimized by dividing the typical coil into m equivalent coils whose total area is equal to that of the typical coil. A material of high magnetic resistance may separate the m equivalent coils from each other to limit their mutual inductance. In each of the m coils may be a core. All of the cores may be attached by appropriate material to an object which is being moved. The inductance of each of the m coils may be m times smaller than the inductance of the typical coil. The lower inductance produces a faster switching coil. For example real time electronic parameter control may apply a high voltage to each parallel coil for fast response. Once a specified voltage is obtained for each coil, they are connected in series real time to minimize power drain. Exceptionally fast coil responses may be obtained in this manner. A similar scheme for an electromechanical coil composed of many loops, an electromechanical composite coil composed of many coils or a combination of the two methods may dramatically improve the response time. Design tradeoffs must be evaluated in relation to the response time, available power, generated force and volume. All components (i.e. capacitors, inductors, resistors, transformers, transistors, any linear/nonlinear component) may have their circuit parameters controlled in real time.

1.) Real time electronic parameter control may be applied to integrated/unintegrated electromechanical devices (i.e. linear/rotary motors, linear/rotary solenoids, magnetic levitation trains, electromagnetic launch systems, electromechanical shock absorbers, any electromechanical device) and to circuit design components (i.e. capacitors, inductors (coils, composite coils), resistors, transistors, transformers, any linear/nonlinear component) and is characterized by:
one (or more) component (i.e. resistor) may be replaced by one or more components (i.e. resistors, capacitors, inductors) of varying impedance (i.e. resistance, capacitance, inductance);
one or more components may be made to function in real time as an integrated component of variable impedance through connecting the components in different ways (i.e. parallel, series, combination parallel and series, use of only part of set);
implemented discretely and on an integrated circuit;
microprocessor control.

2.) Referring to claim 1, a coil/composite coil is characterized by:
coil:
one or more loops;
each loop consists of one or more windings;
the winding may be of arbitrary shape;
the distance between loops is arbitrary;
the voltage/current in each loop may be controlled by appropriate electronics;
the function of the coil is controlled electronically;
the coil may trace out any curve in three dimensional space;
the coil may be coreless or may possess a core;
one or more arbitrarily shaped components may be joined together to form the core (i.e. hollow core, core with a high permeability substance alternating with a low permeability substance along the length, laminated core);
each core component may be of arbitrary composition and different patterned coatings;
each loop may be separated from other loops by material of arbitrary composition;
each winding may be separated from other windings by material of arbitrary composition;
composite coil:
two or more coils;
the cores may be attached by appropriate material to the object being moved;
each coil may be separated from other coils by material of arbitrary composition;
the function of the composite coil is controlled electronically.

3.) Referring to claim 1, by applying real time electronic parameter control to transformers/power supplies (i.e. primary and secondary winding/circuitry), the available power and the form of the available power may be varied in real time.

4.) Referring to claim 1, real time electronic parameter control may rapidly adapt to changing conditions permitting a wide control of signal patterns.

5.) Referring to claim 1, an integrated electromechanical device (all parts within the same structure) may include the electromechanical unit, sensors (i.e. position, velocity, acceleration, torque, force, any appropriate sensor), microprocessor (i.e. control software), appropriate circuitry (i.e. drive electronics), power supply, communications, and appropriate interface port.

6.) Referring to claim 1, real time electronic parameter control may be applied to any parts of the integrated electromechanical device or to any parts of an unintegrated electromechanical device.

7.) Referring to claim 1, real time electronic parameter control may permit exceptionally fast response times for the electromechanical devices improving overall characteristics of the device (i.e. torque/force, speed).
